(19) United States
(12) Patent Application Publication
(10) Pub. No.: US 2017/0194089 A1
(43) Pub. Date: Jul. 6, 2017

(54) COIL COMPONENT

(71) Applicant: Samsung Electro-Mechanics Co., Ltd., Suwon-si (KR)

(72) Inventors: Su Bong JANG, Suwon-si (KR); Won Gi KIM, Suwon-si (KR); Han KIM, Suwon-si (KR); Sang Jong LEE, Suwon-si (KR)

(73) Assignee: Samsung Electro-Mechanics Co., Ltd., Suwon-si (KR)

(21) Appl. No.: 15/270,484

(22) Filed: Sep. 20, 2016

(30) Foreign Application Priority Data
Dec. 30, 2015 (KR) 10-2015-0189472

(51) Int. Cl. H01F 27/29; H01F 27/28

(52) U.S. Cl. CPC H01F 27/29; H01F 27/2804

(57) ABSTRACT

A coil component includes: a coil including connection pads; a first bonding wire connected to a first connection pad among the connection pads; and a second bonding wire connected to a second connection pad among the connection pads.

### CROSS-REFERENCE TO RELATED APPLICATIONS

This application claims benefit of Korean Patent Application No. 10-2015-0189472 filed on Dec. 30, 2015 in the Korean Intellectual Property Office, the entire disclosure of which is incorporated herein by reference for all purposes.

### BACKGROUND

1. Field

The following description relates to a coil component.

2. Description of Related Art

Signals in various frequency bands have been used in smartphone communications due to the implementation of long term evolution (LTE) multiband technology. Thus, in high frequency signal transmitting/receiving radio frequency (RF) systems, high frequency inductors have principally been used as impedance matching circuits, and the use of such high frequency inductors has continued to increase.

Passive devices such as such power inductors for a high frequency and the like have been required to be miniaturized and slimmed due to reductions in mounting areas within sets, such as smartphones and the like, as a result of decreased set sizes and increased space usage within sets by device components due the addition of functions.

Thus, power inductors are required to be reduced in size, leading to the development of embedded-type inductors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil component includes: a coil including connection pads; a first bonding wire connected to a first connection pad among the connection pads; and a second bonding wire connected to a second connection pad among the connection pads.

The first bonding wire and the second bonding wire may be configured as external electrodes allowing the coil component to be electrically connected to an external component.

The first bonding wire may be an input terminal and the second bonding wire may be an output terminal.

The connection pads may be disposed on an upper surface of the coil and may be spaced apart from each other along a shape of an upper surface of the coil.

Widths of coil portions of the coil at positions at which the connection pads are disposed may be wider than widths of coil portions adjacent to the positions at which the connection pads are disposed.

A connection pad, among the connection pads, disposed on an outermost coil portion of the coil may protrude outwardly from the coil.

A connection pad, among the connection pads, disposed on an innermost coil portion of the coil may protrude inwardly from the coil.

The coil may be embedded in a body portion including an upper surface and a lower surface opposing each other in a first direction, first and second surfaces opposing each other in a second direction, and third and fourth surfaces opposing each other in a third direction. An upper surface and a lower surface of the coil may be coplanar with the upper surface and the lower surface of the body portion, respectively.

The body portion may include a ceramic body or a magnetic body.

The coil may include an insulating substrate in contact with a lower surface of the coil.

The first bonding wire and the second bonding wire may include metal wires having a circular shaped cross section.

The first connection pad may be a first active connection pad, and the second connection pad may be a second active connection pad.

An inductance of the coil component may be based on a distance between the first active connection pad and the second active connection pad along a shape of the coil.

An angle formed between a virtual line extending from a center of the coil to the first active connection pad and a virtual line extending from the center of the coil to the second active connection pad may be between 0° and 180°.

An insulating layer may be disposed on a surface of the coil except for portions of the surface of the coil on which the first active connection pad and the second active connection pad are disposed.

The first active connection pad and the second active connection pad may include a metal plating layer disposed on an upper surface of the coil.

In another general aspect, a coil component includes: a body; a coil disposed in the body and including connection pads on a surface of the coil; and bonding wires connected to the connection pads, wherein the bonding wires extend away from the body and are configured to connect the coil component to an external component.

The surface of the coil may be coplanar with a surface of the body.

The body may include a ceramic material or a magnetic material.

Other features and aspects will be apparent from the following detailed description, the drawings, and the claims.

### BRIEF DESCRIPTION OF DRAWINGS

FIG. 1 is a schematic perspective view of a coil component, according to an embodiment.

FIG. 2A is a schematic perspective view of a coil component according to the related art.

FIG. 2B schematically illustrates a flow of magnetic flux in a coil component according to the related art.

FIG. 3A is a table including schematic perspective views and plan views of a coil component according to an embodiment and a coil component according to the related art.

FIG. 3B schematically illustrates distributions of flux of a coil component according to an embodiment and a coil component according to the related art.

FIG. 4A is a schematic table illustrating differences between an inductance (L) and a Q value of a coil component according to an embodiment and an inductance (L) and a Q value of a coil component according to the related art.

FIG. 4B illustrates a difference between an inductance of a coil component according to an embodiment and an inductance of a coil component according to the related art.

FIG. 4C illustrates a difference between a Q value of a coil component according to an embodiment and a Q valued of a coil component according to the related art.

FIG. 5 is a plan view of a coil of FIG. 1.

FIG. 6A illustrates a table representing a change in an inductance (L) value of a modified example of a coil component, according to an embodiment.

FIG. 6B is a graph representing data in the table of FIG. 6A.

Throughout the drawings and the detailed description, the same drawing reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views illustrating embodiments of the disclosure. In the drawings, for example, due to manufacturing techniques and/or tolerances, modifications of the shape shown may be estimated. Thus, embodiments of the disclosure should not be construed as being limited to the particular shapes of regions shown herein, for example, to include a change in shape results in manufacturing. The following embodiments may also be constituted by one of the embodiments or a combination thereof.

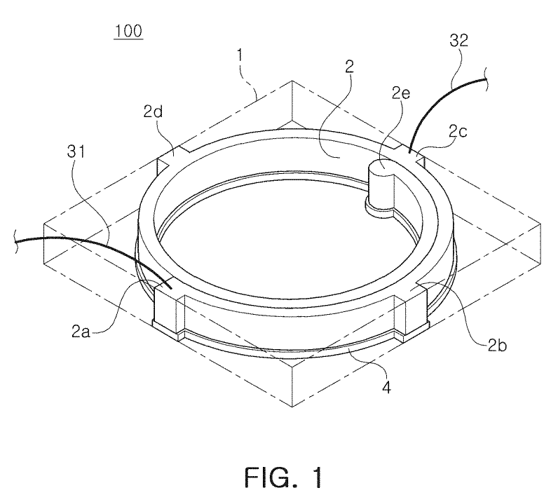

FIG. 1 is a schematic perspective view of a coil component 100, according to an embodiment. With reference to FIG. 1, the coil component 100 includes a coil 2 including a plurality of connection pads 2a, 2b, 2c, 2d and 2e, and a first bonding wire 31 and a second bonding wire 32 connected to the connection pads 2a and 2c.

The coil 2 is embedded in, for example, a body portion 1 illustrated by dotted lines in FIG. 1, but is not limited to such an embedded configuration. For example, when the coil 2 is embedded in the body portion 1, since the body portion 1 forms an appearance of the coil component 100, the body portion 1 fills a peripheral space of the coil 2.

The body portion 1 may be a ceramic body or a magnetic body, but is not limited to such types of bodies. When the body portion 1 is a ceramic body, an Al2O3-B2O3-SiO2-based powder and a CaO—B₂O3-SiO2-based powder may be used, and a dielectric constant and a sintering temperature of the powder may be adjusted according to a ratio of alumina powder and glass frit powder. However, other types of materials and compositions may be used.

In addition, when the body portion 1 is a magnetic body, any material having magnetic characteristics may be used as a material of the body portion 1. For example, the body portion 1 can be formed of a magnetic-resin compound in which a magnetic metal powder and a resin mixture are mixed with each other. However, other types of materials may be used.

The body portion 1 may have first (upper) and second (lower) surfaces opposing each other in a first direction, third and fourth surfaces opposing each other in a second direction, and fifth and sixth surfaces opposing each other in a third direction, to have a substantially parallelepiped shape, but is not limited thereto. The coil 2 may be embedded in the body portion 1. The coil 2 may be disposed to be coplanar with the upper surface and the lower surface of the body portion. Thus, the coil 2 may be embedded in the body portion 1 such that the connection pads 2a, 2b, 2c, 2d and 2e are embedded in the body portion 1.

The coil 2 may have a spiral shape or other shapes. The coil 2 may be formed to include a metal having relatively excellent electrical conductivity, and may be formed of silver (Ag), palladium (Pd), aluminum (Al), nickel (Ni), titanium (Ti), gold (Au), Copper (Cu), platinum (Pt), an alloy thereof, or the like.

The connection pads 2a, 2b, 2c, 2d, and 2e may be disposed on an upper surface of the coil 2. With reference to FIG. 1, although five connection pads 2a, 2b, 2c, 2d, and 2e are shown and described, the number of connection pads may be adjusted as needed, depending on a manufacturing process, a desired design, or the like. In addition, in order to provide connection pads connected to the first bonding wire 31 and the second bonding wire 32, respectively, at least two connection pads may be provided.

The connection pads 2a, 2b, 2c, 2d, and 2e may be disposed on an upper surface of the coil 2 and may be disposed to be spaced apart from each other while following a shape of an upper surface of the coil 2. In this case, since the shape of an upper surface of the coil 2 in FIG. 1 is a spiral, the connection pads may be disposed on an upper surface of the coil 2 while following the spiral shape thereof.

With reference to FIG. 1, the connection pad 2a disposed on one end of the coil 2 is connected to the first bonding wire 31. Due to being connected to the first bonding wire 31, the connection pad 2a may be referred to as a first active connection pad.

The connection pad 2c, which is connected to the second bonding wire 32, may be disposed to be spaced apart from the first active connection pad 2a while following a shape of an upper surface of the coil 2, for example, a spiral shape. Due to being connected to the second bonding wire 32, the connection pad 2c may be referred to as a second active connection pad.

According to an embodiment, the first active connection pad and the second active connection pad indicate connection pads, among connection pads disposed in the coil, connected to the first bonding wire and the second bonding wire, respectively, which may be variably set according to a required design. Thus, a level of inductance may be easily varied to implement multiple levels of inductance. A method in which the first bonding wire is connected to the first active connection pad and the second bonding wire is connected to the second active connection pad is not particularly limited.

For example, a peripheral space of the coil including connection pads is filled by the body portion, and the first and second active connection pads are determined and disposed in positions in which they are electrically connected to the first and second bonding wires, respectively. Subsequently, an external surface of the body portion including vertically extended regions of the determined first and second active connection pads is etched mechanically or chemically, to thus allow the first and second active connection pads embedded in the body portions to be exposed. In addition, plating layers formed of a metal such as gold (Au), or the like, having electrical conductivity may be disposed on exposed upper surfaces of the first and second active connection pads to be connected to the first and second bonding wires, respectively. The plating layers may also be formed of materials other than gold.

In addition, an insulating substrate 4 is disposed on a lower surface of the coil 2. The insulating substrate 4 may include a polypropylene glycol (PPG) substrate, a ferrite substrate, a metal flexible substrate, or the like. However, other materials are possible. The insulating substrate 4 may be a member supporting the coil.

The first and second bonding wires 31 and 32 are provided as external electrodes allowing the coil component 100 to be electrically connected to external components. The first bonding wire 31 and the second bonding wire 32 may be an input terminal and an output terminal, respectively.

In addition, the first bonding wire and the second bonding wire may be metal wires having a circular cross sectional shape, and may be formed to include a metal having excellent electrical conductivity. In detail, the first bonding wire 31 and the second bonding wire 32 may be formed of nickel, copper, tin, or silver, or an alloy thereof.

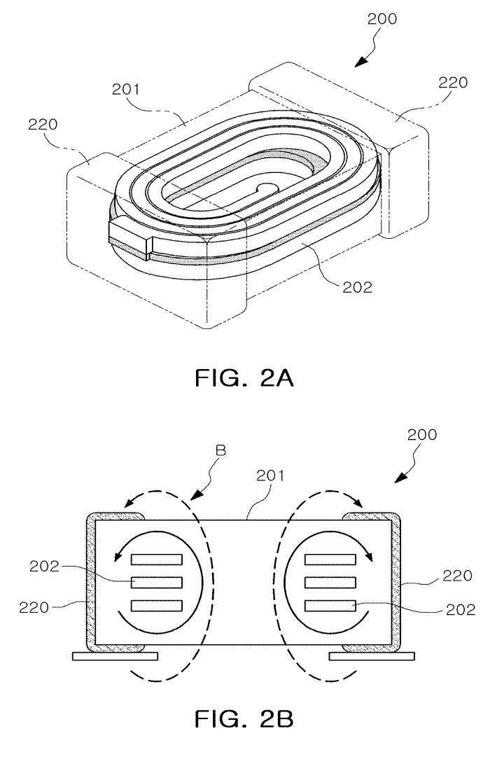

FIGS. 2A and 2B respectively illustrate a structure of a coil component 200 according to the related art and an influence of magnetic flux B from external electrodes 220 in the structure of the coil component 200.

First, with reference to FIG. 2A, the external electrodes 220 in the coil component 200 according to the related art are respectively disposed on external surfaces of a magnetic body 201 to be electrically connected to lead-out terminals of internal electrodes exposed to the external surfaces of the magnetic body. In this case, the external electrodes 220 generally have a “[ ]” shaped transverse cross section or “ [symbol] ” shaped transverse cross sections.

However, as illustrated in FIG. 2B, the coil component 202 including the external electrodes 220 according to the related art causes eddy current loss due to the external electrodes 220, as well as loss of a magnetic field generated in the coil component 200, thus causing loss of a Q value of the coil component 200.

However, a coil component according to embodiments disclosed herein may include a first bonding wire and a second bonding wire as external electrodes, and thus, the loss of eddy current due to external electrodes and the loss of a Q value caused thereby may be prevented. In addition, since the first bonding wire and the second bonding wire include a metal wire having excellent electrical conductivity and are electrically connected to external components, an external electrode function may be provided using the first and second bonding wires alone.

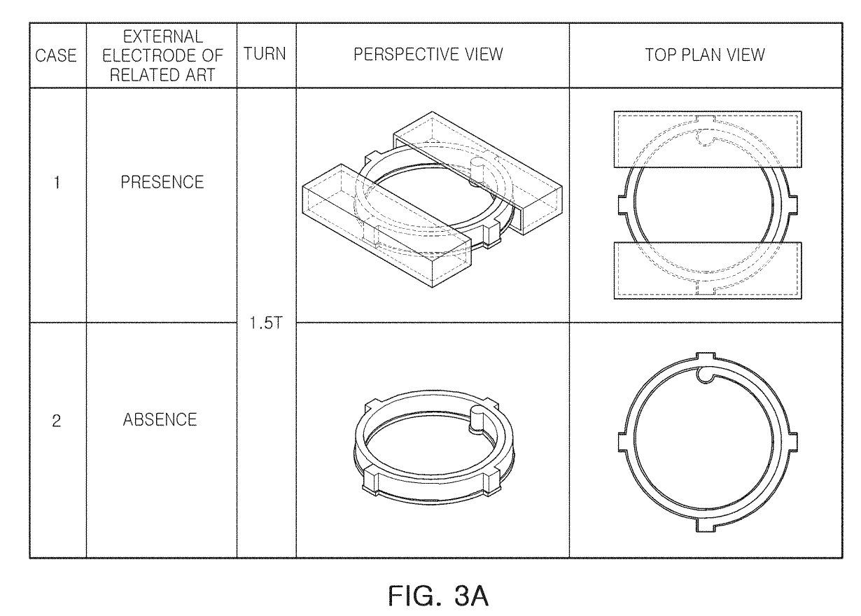

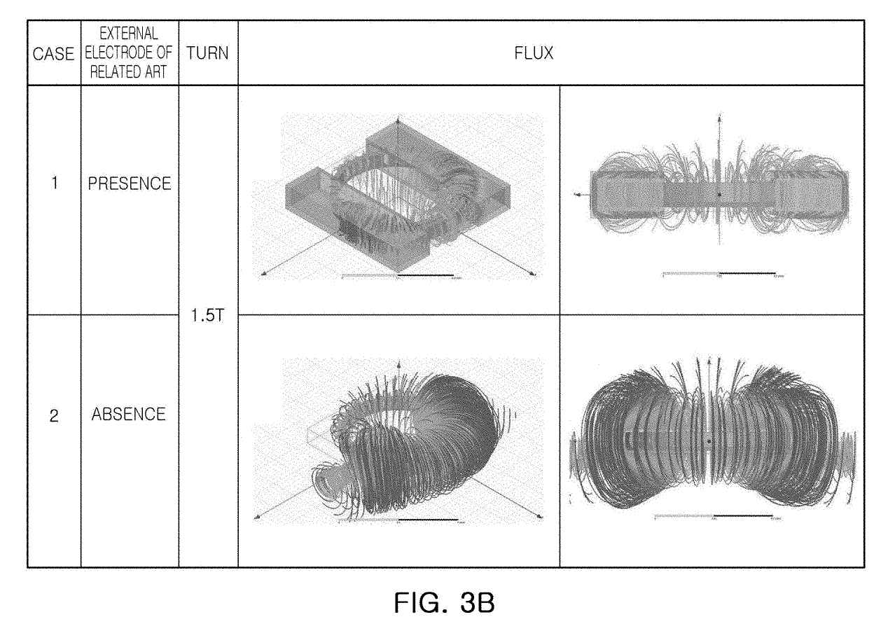

FIGS. 3A and 3B illustrate a difference between magnetic flux in a coil component according to embodiment disclosed herein and magnetic flux in a coil component according to the related art due to a structural difference therebetween.

First, with reference to FIG. 3A, in the case of a coil component (case 1) according to the related art, external electrodes having a “[ ]” shaped transversal cross section are disposed on two external surfaces of a body portion opposing each other, respectively, while in the case of a coil component (case 2) according to an embodiment disclosed herein, a first bonding wire and a second bonding wire (not shown) are disposed on a first active connection pad disposed on an end of an outermost portion of the coil (“coil portion”) and a second active connection pad disposed on an end of an innermost coil portion of a coil provided by being wound by 1.5 turns from the end of the outermost coil portion, respectively.

In the case of the coil component (case 2) according to an embodiment disclosed herein, a wire is used as an external electrode, thereby preventing loss of flux due to an induced current of an external electrode of the related art. Thus, inductance (L) and equivalent serial resistance (Rs) of a coil component may be improved to improve a Q value, a quality factor of the coil component. Accordingly, the coil component according to an embodiment disclosed herein may have an improved Q value without changing an overall structure and a material of a coil of the coil component.

With reference to FIG. 3B, it can be clearly confirmed that there is a difference in flux between the coil component (case 1) of the related art and the coil component (case 2) according to the embodiment disclosed herein. In the coil component disclosed herein, since loss of flux due to an induced current by an external electrode does not occur, in comparison to the coil component of the related art, and an area of the coil component having an influence due to a magnetic flow may be relatively extended. Therefore, flux strength of the coil component may also be further increased.

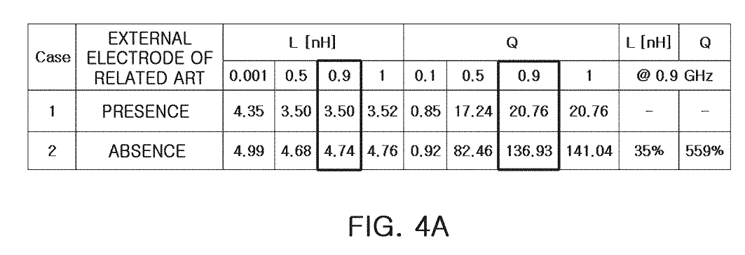

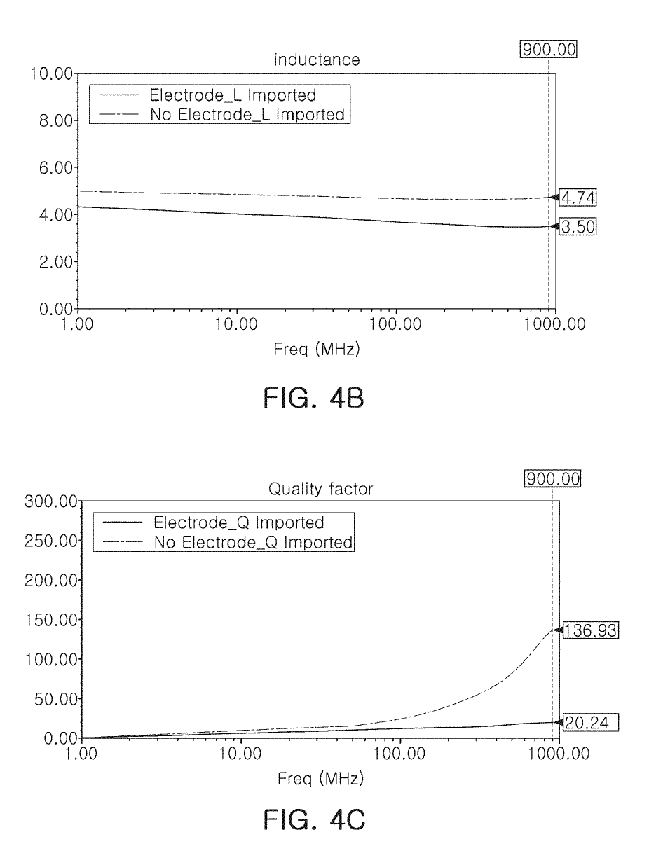

FIGS. 4A to 4C illustrate a difference between inductance (L) and a Q value of the coil component (case 1) of the related art and inductance (L) and a Q value of the coil component (case 2) according to an embodiment disclosed herein.

First, FIG. 4A is a table illustrating measurement values obtained by measuring inductance (L) and Q values of the coil component (case 1) of the related art and the coil component (case 2) according to an embodiment disclosed herein while applying various frequencies to the respective coil components. Referring to the table of FIG. 4A, in the case of the coil component (case 2) of the embodiment disclosed herein, for example, in a high frequency region of 0.9 GHz, inductance and a Q value of are significantly increased as compared to the coil component of the related art, which includes an external electrode structure. In detail, it can be confirmed that inductance of the coil component disclosed herein is increased by about 35% in comparison to the coil component of the related art, and a Q value of the embodiment disclosed herein is improved by about 559% in comparison to the coil component of the related art. The results in FIG. 4A are explained in more detail through the graphs of FIGS. 4B and 4C.

FIG. 4B illustrates a difference between inductance of the coil component (case 1—represented by a solid line) of the related art, which includes an external electrode, and inductance of the coil component (case 2—represented by a dotted line) according to the embodiment disclosed herein, in which a first bonding wire and a second bonding wire are used and a coil is wound by 1.5 turns. With reference to FIG. 4B, a relatively great difference between the dotted line and the solid line in various frequency regions indicates that the coil component according to the embodiment disclosed herein exhibits excellent improvements in inductance.

Next, FIG. 4C illustrates a difference between a quality factor (Q value) of the coil component (case 1—represented by a solid line) of the related art, which includes an external electrode, and a quality factor of the coil component (case 2—represented by a dotted line) according to the embodiment disclosed herein, in which a first bonding wire and a second bonding wire are used and a coil is wound by 1.5 turns. A relatively great difference exists between the dotted line and the solid line in a high frequency region of 0.9 GHz which indicates that the coil component according to the embodiment disclosed herein has positive attributes in that the coil component has an improved Q value in a high frequency region.

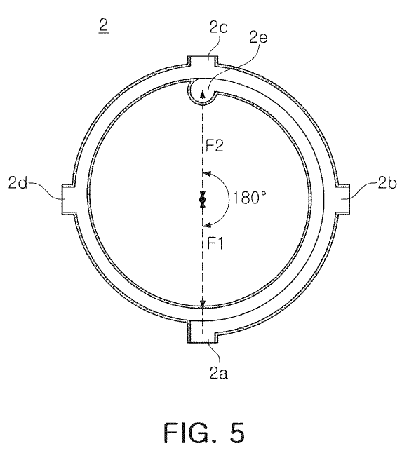

FIG. 5 is a schematic plan view of the coil 2 of FIG. 1. Referring back to FIG. 1, the coil component 100 (FIG. 1) includes the first bonding wire 31 (FIG. 1) and the second bonding wire 32 (FIG. 1) without including an external electrode covering portions of the upper surface or the lower surface of the magnetic body/body portion 1 (FIG. 1). Referring to FIG. 5, in this case, the first bonding wire 31 is connected to the connection pad 2a disposed on an end of an outermost coil portion, and the second bonding wire 32 is connected to the connection pad 2e disposed on an end of an innermost coil portion. Thus, the connection pads 2a and 2e serve as a first active connection pad and a second active connection pad, respectively. However, the coil component 100 is not limited to such a configuration of first and second bonding wires and the first and second active connection pads.

In addition, FIG. 5 illustrates the coil including connection pads 2a, 2b, 2c, 2d, and 2e spaced apart from one other by a uniform distance interval following a shape of an upper surface of the coil 2. However, the coil 2 is not limited to such a configuration. The number of connection pads disposed on an upper surface of the coil 2, a distance interval between adjacent connection pads, a structure of the coil 2, the number of turns of the coil 2, a structure of the connection pads, and the like may be varied according to the need for alterations in a manufacturing process or a design, and the like.

With reference to FIG. 5, an angle formed between a virtual line F1 extending from a center of the coil 2 to the first active connection pad 2a and a virtual line F2 extending from a center of the coil 2 to the second active connection pad 2e is, for example, 180°, but is not limited thereto. For example, in order to obtain a required inductance level, the angle with respect to each other can be varied within a range of 0° to 180°. While the angle formed between the virtual lines F1 and F2 is represented as being within the range of 0° to 180°, the angle formed between the virtual lines F1 and F2 may actually be within a range of 0° to 360°, depending on the locations of the first and second active connection pads.

With reference to FIG. 5, widths of coil portions at positions in which the connection pads 2a, 2b, 2c, 2d and 2e are disposed may be wider than a width of coil portions at adjacent positions in which a connection pad is not formed. Thus, a space allowing for an easy connection of the connection pads to the first and second bonding wires 31 and 32 may be provided, and this space may allow an external surface of the body portion 1 and the coil 2 to be easily connected to each other.

More specifically, for example, the connection pad 2a, which is disposed on an outermost coil portion, has a form protruding outwardly from the coil 2 to allow for an increase in a width of the coil portion. Similarly, the connection pads 2b, 2c and 2d, which are disposed on outer coil portions, have forms protruding outwardly from the coil 2. In a different manner, for example, the connection pad 2e, which is disposed on an innermost coil portion, has a form protruding toward a central portion of the coil to allow for an increase in a width of the coil portion. Such configurations of the connection pads 2a, 2b, 2c, 2d and 2e provide increased widths of coil portions at positions at which the connection pads 2a, 2b, 2c, 2d and 2e are disposed, relative to remaining coil portions, thereby providing stability of the coil 2 at the positions of connection pads 2a, 2b, 2c, 2d and 2e. Further, a distance between adjacent coil portions is maintained to be relatively narrow, and thus the coil component 100 may be miniaturized. In addition, as the number of turns of the coil 2 is increased, a level of inductance may be sufficiently improved.

In addition, an insulating layer may be disposed on a surface of the coil 2 to prevent short circuits between adjacent coil portions. In this case, an upper surface of the coil on which the first active connection pad 2a and the second active connection pad 2e are disposed may not be provided with an insulating layer thereon, to allow for connection to the first and second bonding wires 31 and 32. The insulating layer may include an insulating film formed through coating of a polymer material including, for example, an epoxy resin, a polyimide resin, or the like.

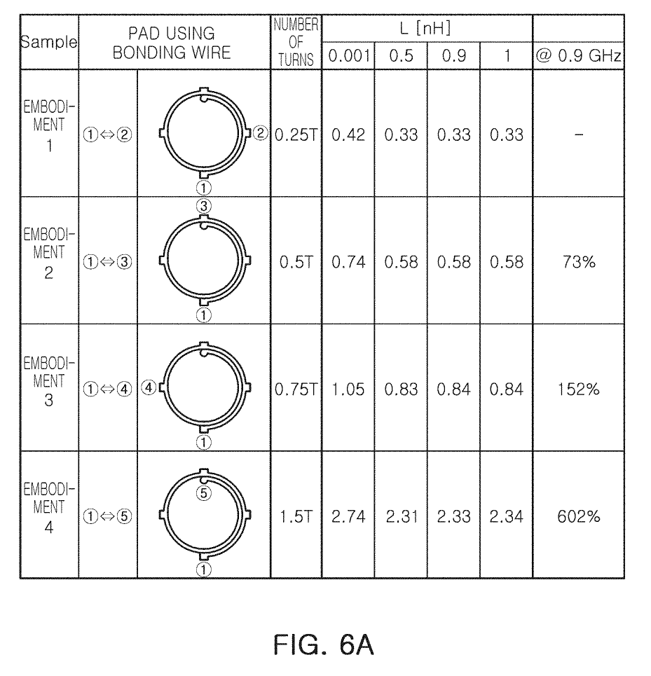

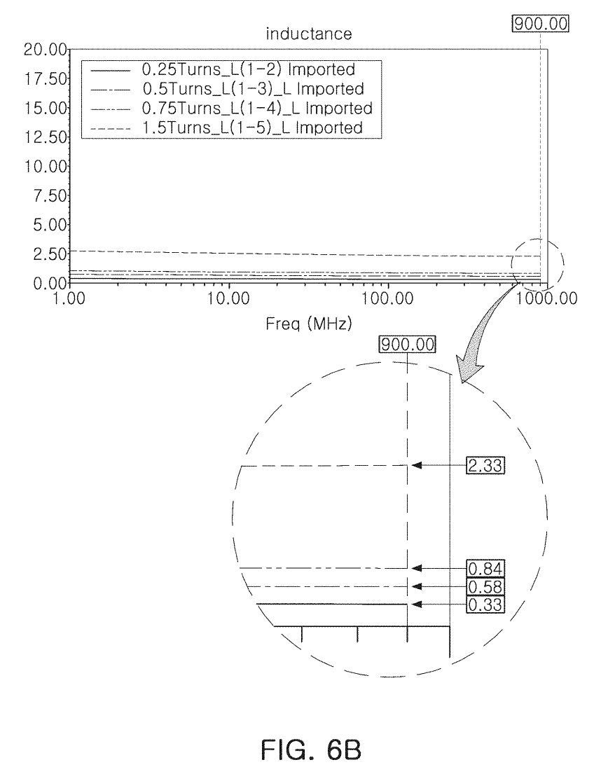

FIG. 6A illustrates a table representing inductance measured by maintaining a first active connection pad connected to the first bonding wire 31 as the connection pad 2a disposed on an end of an outermost coil portion, while sequentially changing a position of a second active connection pad connected to the second bonding wire 32. It should be understood that Embodiments 1-5 in FIG. 6A are merely examples, and any number of different embodiments including different arrangements of first and second active connection pads are possible. FIG. 6B is a graph representing the data provided in the table of FIG. 6A.

In Embodiment 1 of FIG. 6A, the connection pad 2a (FIG. 1), positioned on an end of an outermost coil portion, is set to be the first active connection pad, and the connection pad 2b (FIG. 1), disposed at a distance 0.25 turn from the end of the outermost coil portion following a shape of the coil 2, is set to be the second active connection pad. In this case, an angle formed by the first and second active connection pads 2a and 2b with respect to a center of the coil is 90°, and inductance of the coil component 2 is 0.33 pH in a high frequency region of 0.9 GHz.

In Embodiments 2 to 4, the connection pads 2c to 2e (FIG. 1), respectively, are set as the second active connection pad. The connection pads 2c, 2d and 2e are respectively located 0.5 turn, 0.75 turn and 1.5 turns from the connection pad 2a disposed on the end of the outermost coil portion, following a shape of the coil 2. In Embodiments 2 to 4, angles formed between the first and second active connection pads with respect to a center of the coil 2 are 180°, 90°, and 180°, respectively, and inductances of the coil component 100 are 0.58 pH, 0.84 pH, and 2.33 pH, respectively, in a high frequency region of 0.9 GHz.

In further detail, with reference to the graph of FIG. 6B, it can be appreciated that the inductance of a coil component may be easily changed by controlling a distance extended between the first active connection pad to the second active connection pad, following a shape of the coil.

With reference to FIG. 6B, the inductance of the coil component 100 of Embodiment 1 is represented by a solid line, the inductance of the coil component 100 of Embodiment 2 is represented by a line including alternating long and short dashes, the inductance of the coil component 100 of Embodiment 3 is represented by a line including an alternating single long dash and double short dash, and the inductance of the coil component 100 of Embodiment 4 is represented by a dotted line. In Embodiment 4, since a distance between the first active connection pad 2a and the second active connection pad 2e is set to be the greatest (1.5 turns) as compared to Embodiments 1 to 3, the coil component of Embodiment 4 has a greatest inductance value of 2.33 pH in the same frequency region of 900 MHz, which is a value increased by about 602% as compared to the inductance of 0.33 pH in the frequency region of 900 MHz of Embodiment 1.

According to embodiments disclosed herein, a coil component having a bonding wire in a form different from the form of an external electrode of the related art is provided. Thus, the coil component may be miniaturized. Additionally, a coil component having various capacity levels in which multiple levels of inductance may be easily controlled is provided. Additionally, since loss of an eddy current due to an external electrode in the related art may be prevented, a coil component having an improved quality factor, namely a Q characteristic, may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil component, comprising:
a coil comprising connection pads;
a first bonding wire connected to a first connection pad among the connection pads; and
a second bonding wire connected to a second connection pad among the connection pads.

2. The coil component of claim 1, wherein the first bonding wire and the second bonding wire are configured as external electrodes allowing the coil component to be electrically connected to an external component.

3. The coil component of claim 1, wherein the first bonding wire is an input terminal and the second bonding wire is an output terminal.

4. The coil component of claim 1, wherein the connection pads are disposed on an upper surface of the coil and are spaced apart from each other along a shape of the upper surface of the coil.

5. The coil component of claim 1, wherein widths of coil portions of the coil at positions at which the connection pads are disposed are wider than widths of coil portions adjacent to the positions at which the connection pads are disposed.

6. The coil component of claim 1, wherein a connection pad, among the connection pads, disposed on an outermost coil portion of the coil protrudes outwardly from the coil.

7. The coil component of claim 1, wherein a connection pad, among the connection pads, disposed on an innermost coil portion of the coil protrudes inwardly from the coil.

8. The coil component of claim 1, wherein:
the coil is embedded in a body portion comprising an upper surface and a lower surface opposing each other in a first direction, first and second surfaces opposing each other in a second direction, and third and fourth surfaces opposing each other in a third direction; and
an upper surface and a lower surface of the coil are coplanar with the upper surface and the lower surface of the body portion, respectively.

9. The coil component of claim 8, wherein the body portion comprises a ceramic body or a magnetic body.

10. The coil component of claim 1, wherein the coil comprises an insulating substrate in contact with a lower surface of the coil.

11. The coil component of claim 1, wherein the first bonding wire and the second bonding wire comprise metal wires having a circular shaped cross section.

12. The coil component of claim 1, wherein the first connection pad is a first active connection pad, and the second connection pad is a second active connection pad.

13. The coil component of claim 12, wherein an inductance of the coil component is based on a distance between the first active connection pad and the second active connection pad along a shape of the coil.

14. The coil component of claim 12, wherein an angle formed between a virtual line extending from a center of the coil to the first active connection pad and a virtual line extending from the center of the coil to the second active connection pad is between 0° and 180°.

15. The coil component of claim 12, wherein an insulating layer is disposed on a surface of the coil except for portions of the surface of the coil on which the first active connection pad and the second active connection pad are disposed.

16. The coil component of claim 12, wherein the first active connection pad and the second active connection pad comprise a metal plating layer disposed on an upper surface of the coil.

17. A coil component, comprising:
a body;
a coil disposed in the body and comprising connection pads on a surface of the coil; and
bonding wires connected to the connection pads, wherein the bonding wires extend away from the body and are configured to connect the coil component to an external component.

18. The coil component of claim 17, wherein the surface of the coil is coplanar with a surface of the body.

19. The coil component of claim 17, wherein the body comprises a ceramic material or a magnetic material.
